(19) United States
(12) Patent Application Publication
(10) Pub. No.: US 2026/0278724 A1
(43) Pub. Date: Sep. 17, 2026

(54) SYSTEM FOR PREDICTING PROGRESS OF SPORTS MATCH IN REAL TIME

(71) Applicant: SoftBank Group Corp., Tokyo (JP)

(72) Inventor: Fumiyasu ABE, Tokyo (JP)

(21) Appl. No.: 19/557,128

(22) Filed: Mar. 5, 2026

Related U.S. Application Data
(60) Provisional application No. 63/769,767, filed on Mar. 11, 2025.

(51) Int. Cl. G06Q 50/34; G06Q 10/04

(52) U.S. Cl. CPC G06Q 50/34; G06Q 10/04

(57) ABSTRACT

An innovative sports betting system that utilizes generative AI and 5G technology. A generative AI unit generates a model that predicts the development of a match and the performance of players based on past match data, player conditions, weather conditions, and the like. A 5G communication unit acquires real-time data from a match venue with low latency and transmits it to a data analysis unit. The data analysis unit uses the model provided from the generative AI unit to calculate the probability of occurrence of events during a match and to generate betting odds. A user interface unit provides an environment where a user can view odds information that is updated in real time and place bets.

### CROSS-REFERENCE TO RELATED APPLICATIONS

This application is based upon and claims the benefit of priority from U.S. Provisional Patent Application No. 63/769,767, filed on Mar. 11, 2025, the entire contents of which are incorporated herein by reference.

### BACKGROUND

Japanese Unexamined Patent Publication No. 2022-180282 discloses a method, which is a personal chatbot control method performed by at least one processor, the method including a step of receiving a user utterance, a step of adding the user utterance to a prompt including an instruction sentence associated with a description regarding a character of a chatbot, a step of encoding the prompt, and a step of inputting the encoded prompt to a language model to generate a chatbot utterance responding to the user utterance.

### SUMMARY

A problem to be solved by this disclosure is to improve real-time performance and prediction accuracy in sports betting. In conventional sports betting systems, it has been difficult to respond quickly to changes in the situation during a match, and because the accuracy of predictions is insufficient, it has not been possible to provide attractive betting opportunities for users. As a result, it has not been possible to enhance the excitement of watching sports, which has been a factor hindering the growth of the entire sports industry.

By combining generative AI and 5G technology, real-time data during a match may be quickly collected and the development of the match and the performance of players may be predicted with high accuracy using an advanced prediction model by AI. This makes it possible to instantly probabilize events during a match and update odds in real time, thereby providing a more dynamic and exciting betting experience to users.

Furthermore, this system significantly enhances the appeal of watching sports by providing visually easy-to-understand information through a user interface and enabling users to make quick decisions. The objective is to support the growth and development of the sports industry by increasing interest in sports and making the viewing experience more attractive.

Disclosed herein is a system including a generative AI unit, a 5G communication unit, and a data analysis unit. The generative AI unit acquires real-time data related to a sports event and generates a model for predicting the development of a match and the performance of players by combining it with past statistical data. This model is used to calculate the probability of occurrence of events during a match with high accuracy.

The 5G communication unit provides a communication means for acquiring real-time data with low latency and transmitting it to the data analysis unit. This makes it possible to respond quickly to changes in the situation during a match and to provide users with odds that are updated in real time.

The data analysis unit performs processing to calculate the probability of occurrence of events during a match and to generate betting odds, using the model provided from the generative AI unit. This processing allows users to place bets based on the real-time situation during a match, making it possible to enhance the excitement of watching sports.

These components make it possible to achieve improvements in real-time performance and prediction accuracy in sports betting, and to provide a more attractive betting experience to users. The objective is to support the growth and development of the sports industry by increasing interest in sports and making the viewing experience more attractive.

### BRIEF DESCRIPTION OF THE DRAWINGS

FIG. 1 is a conceptual diagram illustrating an example of a configuration of a data processing system according to a first embodiment.

FIG. 2 is a conceptual diagram illustrating an example of main functions of a data processing apparatus and a smart device according to the first embodiment.

FIG. 3 is a conceptual diagram illustrating an example of a configuration of a data processing system according to a second embodiment.

FIG. 4 is a conceptual diagram illustrating an example of main functions of a data processing apparatus and smart glasses according to the second embodiment.

FIG. 5 is a conceptual diagram illustrating an example of a configuration of a data processing system according to a third embodiment.

FIG. 6 is a conceptual diagram illustrating an example of main functions of a data processing apparatus and a headset-type terminal according to the third embodiment.

FIG. 7 is a conceptual diagram illustrating an example of a configuration of a data processing system according to a fourth embodiment.

FIG. 8 is a conceptual diagram illustrating an example of main functions of a data processing apparatus and a robot according to the fourth embodiment.

FIG. 9 illustrates an emotion map on which a plurality of emotions are mapped.

FIG. 10 illustrates an emotion map on which a plurality of emotions are mapped.

FIG. 11 is a flowchart illustrating an example method of predicting the progress of a sports match in real time.

### DETAILED DESCRIPTION

Hereinafter, example systems according to the technology of the present disclosure will be described with reference to the accompanying drawings.

First, terms used in the following description will be described.

In the following embodiments, a processor with a reference sign (hereinafter, simply referred to as a “processor”) may be one arithmetic device or may be a combination of a plurality of arithmetic devices. Also, the processor may be one type of arithmetic device or may be a combination of a plurality of types of arithmetic devices. Examples of the arithmetic device include a CPU (Central Processing Unit), a GPU (Graphics Processing Unit), a GPGPU (General-Purpose computing on Graphics Processing Units), an APU (Accelerated Processing Unit), and the like.

In the following embodiments, a RAM (Random Access Memory) with a reference sign is a memory in which information is temporarily stored, and is used as a work memory by a processor.

In the following embodiments, a storage with a reference sign is one or more non-volatile storage devices that store various programs, various parameters, and the like. Examples of the non-volatile storage device include a flash memory (SSD (Solid State Drive)), a magnetic disk (for example, a hard disk), or a magnetic tape, and the like.

In the following embodiments, a communication I/F (Interface) with a reference sign is an interface including a communication processor, an antenna, and the like. The communication I/F manages communication among a plurality of computers. An example of a communication standard applied to the communication I/F includes a wireless communication standard including 5G (5th Generation Mobile Communication System), Wi-Fi (registered trademark), or Bluetooth (registered trademark), and the like.

In the following embodiments, “A and/or B” is synonymous with “at least one of A and B”. That is, “A and/or B” means that it may be only A, may be only B, or may be a combination of A and B. Also, in the present specification, when three or more matters are expressed by being connected with “and/or”, the same concept as “A and/or B” is applied.

### First Embodiment

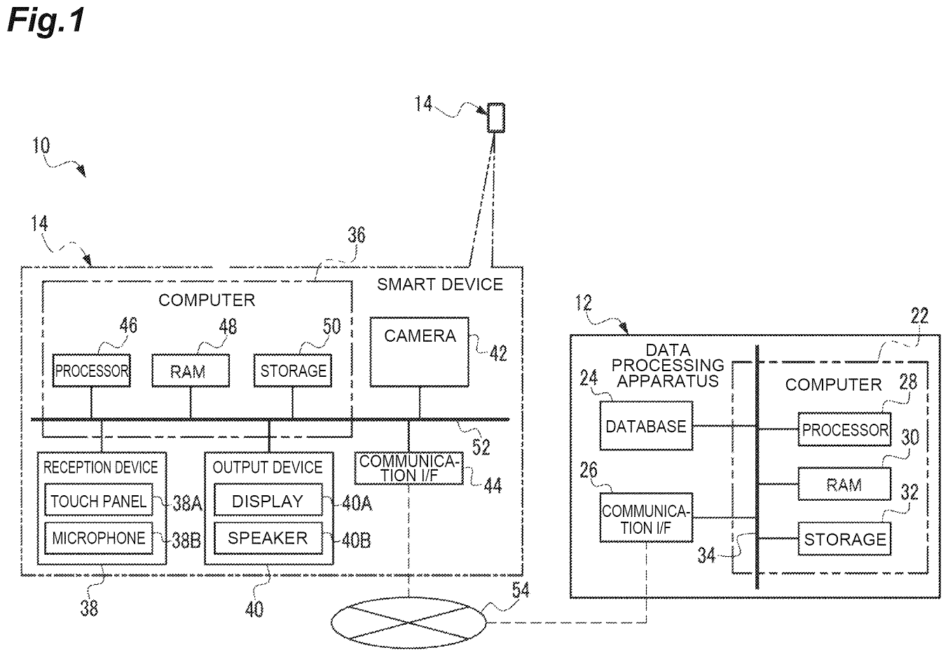

FIG. 1 illustrates an example of a configuration of a data processing system 10 according to a first embodiment.

As illustrated in FIG. 1, the data processing system 10 includes a data processing apparatus 12 and a smart device 14. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. Also, the reception device 38, the output device 40, and the camera 42 are also connected to the bus 52.

The reception device 38 includes a touch panel 38A, a microphone 38B, and the like, and receives a user input. The touch panel 38A receives a user input by contact of an indicator by detecting contact of the indicator (for example, a pen or a finger, etc.). The microphone 38B receives a user input by voice by detecting a user's voice. A control unit 46A transmits data indicating the user input received by the touch panel 38A and the microphone 38B to the data processing apparatus 12. In the data processing apparatus 12, a specific processing unit 290 acquires the data indicating the user input.

The output device 40 includes a display 40A, a speaker 40B, and the like, and presents data to a user 20 by outputting the data in a form perceivable by the user 20 (for example, voice and/or text). The display 40A displays visible information such as text and images in accordance with an instruction from the processor 46. The speaker 40B outputs voice in accordance with an instruction from the processor 46. The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted.

The communication I/F 44 is connected to the network 54. The communication I/Fs 44 and 26 manage exchange of various information between the processor 46 and the processor 28 via the network 54.

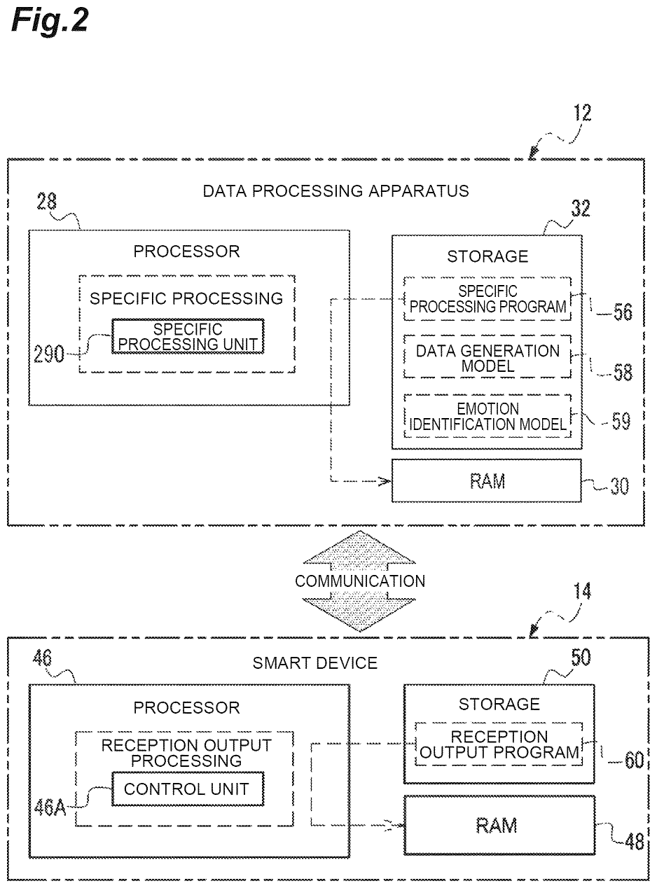

FIG. 2 illustrates an example of main functions of the data processing apparatus 12 and the smart device 14.

As illustrated in FIG. 2, in the data processing apparatus 12, specific processing is performed by the processor 28. A specific processing program 56 is stored in the storage 32. The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart device 14, reception output processing is performed by the processor 46. A reception output program 60 is stored in the storage 50. The reception output program 60 is used in combination with the specific processing program 56 by the data processing system 10. The processor 46 reads the reception output program 60 from the storage 50 and executes the read reception output program 60 on the RAM 48. The specific processing is realized by the processor 46 operating as a control unit 46A in accordance with the reception output program 60 executed on the RAM 48. Note that the smart device 14 may have a data generation model and an emotion identification model similar to the data generation model 58 and the emotion identification model 59, and can also perform processing similar to that of the specific processing unit 290 using these models. The reception output processing is realized by the processor 46 operating as the control unit 46A in accordance with the reception output program 60 executed on the RAM 48.

Note that an apparatus other than the data processing apparatus 12 may have the data generation model 58. For example, a server apparatus (for example, a generation server) may have the data generation model 58. In this case, the data processing apparatus 12 obtains a processing result (such as a prediction result) in which the data generation model 58 is used, by communicating with the server apparatus having the data generation model 58. Also, the data processing apparatus 12 may be a server apparatus, or may be a terminal device owned by a user (for example, a mobile phone, a robot, a home appliance, etc.). Next, an example of processing by the data processing system 10 according to the first embodiment will be described.

The data generation model 58 is configured to include, for example, a neural network based on a Transformer architecture. This model has a Multi-Head Attention Mechanism and calculates temporal dependency and importance between elements in parallel for input time-series data (event logs of a match or vehicle sensor data). This enables prediction considering long-term context dependency, which was difficult to process with a conventional RNN (Recurrent Neural Network). Also, the data generation model 58 may be fine-tuned using Reinforcement Learning from Human Feedback (RLHF) in order to improve inference accuracy. Furthermore, in order to reduce the weight of the model, a configuration may be adopted in which quantization or distillation technology is applied to reduce latency of inference processing on the edge device (the smart device 14 or the vehicle) side.

### Example 1.1

A flow of specific processing in Example 1.1 will be described. Each unit of the system described below is realized by the data processing apparatus 12 and the smart device 14. Also, the data processing apparatus 12 is referred to as a “server”, and the smart device 14 is referred to as a “terminal”.

A sports betting system utilizing generative AI and 5G technology with a server and a terminal will be described more specifically and in detail.

The entire system is composed of two main components: a server and a user terminal. The server is responsible for the main processing, including a generative AI unit, a data analysis unit, and a 5G communication unit, and the user terminal provides a user interface and manages interaction with the user.

The configuration on the server side is as follows.

### 1. Generative AI Unit:

The generative AI unit collects real-time data related to a sports event and generates a model for predicting the development of the match and the performance of players by combining it with past statistical data.
For example, it acquires past match results, player conditions, weather conditions, team tactics, and individual player performance indicators (for example, shooting success rate, running distance, pass success rate, etc.) from a database and trains an AI model.
The AI model calculates the probability of occurrence of events during a match with high accuracy using a machine learning algorithm. This model utilizes neural networks and deep learning technology to recognize complex patterns and improve prediction accuracy.

### 2. Data Analysis Unit:

The data analysis unit uses the model provided from the generative AI unit to calculate the probability of occurrence of events during a match and to generate betting odds.
It performs processing to update the odds in real time according to changes in the situation during the match. For example, if an important player is injured, if there is an unexpected score, or if the flow of the match changes abruptly, the odds are adjusted immediately.
The data analysis unit integrates information from multiple data sources and implements an advanced algorithm to support real-time decision-making.

### 3. 5G Communication Unit:

The 5G communication unit provides a communication means for acquiring real-time data with low latency and transmitting it to the data analysis unit.
For example, it ensures real-time performance by receiving a live data stream from the match venue and instantly transferring it to the server. This makes it possible to respond quickly to changes in the situation during a match.
By utilizing 5G technology, it processes large amounts of data at high speed and provides users with information that is updated in real time.

The 5G communication unit (communication I/Fs 26, 44) may construct a logical network dedicated to this system using network slicing technology. This guarantees a bandwidth for Ultra-Reliable and Low Latency Communications (URLLC) necessary for odds updates in sports betting and autonomous driving control. Furthermore, a part of the functions of the data processing apparatus 12 (for example, primary data analysis or filtering) may be arranged on an edge server (MEC: Multi-access Edge Computing) of a 5G network. This reduces the time for data to pass through a core network and minimizes physical transmission delay, thereby realizing real-time processing on a millisecond level that exceeds the speed at which a human can perceive or react to sudden changes in the situation during a match or traffic accident risks.

The configuration on the user terminal side is as follows.

1. User interface:
The user interface provides an environment where a user can view odds information that is updated in real time and place bets.
The interface is designed to be visually easy to understand and has a function to display fluctuations in odds in a graph and to notify of important events.
For example, a user can use a smartphone or tablet to check the progress of a match and the fluctuation of odds in real time, and quickly place a bet. The user interface has intuitive operability and is designed so that a user can easily make a betting selection.
It also has a function to display the user's past betting history and current betting status, and provides information for the user to review their own betting strategy.

In this way, through the cooperative operation of the server and the terminal, it is possible to achieve improvements in real-time performance and prediction accuracy in sports betting, and to provide a more attractive betting experience to users. The objective is to support the growth and development of the sports industry by increasing interest in sports and making the viewing experience more attractive.

### (System Configuration)

The system includes a generative AI unit, a data analysis unit, a 5G communication unit, and a user interface unit. The generative AI unit collects real-time data related to a sports event and generates a model for predicting the development of the match and the performance of players by combining it with past statistical data. This model is used to calculate the probability of occurrence of events during a match with high accuracy. For example, it acquires past match results, player conditions, weather conditions, team tactics, and individual player performance indicators (for example, shooting success rate, running distance, pass success rate, etc.) from a database and trains an AI model. The AI model uses a machine learning algorithm to recognize complex patterns and improve prediction accuracy. Specific examples of prompt sentences to be read into the generative AI include “Predict the goal success probability of player A in the next match” and “Calculate the probability of team B winning the next match”.

The generative AI unit may be constituted by, for example, the computer 22 (the processor 28, etc.) of the data processing apparatus 12, or may be constituted by the specific processing unit 290, the specific processing program 56, or the like.

The data analysis unit uses the model provided from the generative AI unit to calculate the probability of occurrence of events during a match and to generate betting odds. This unit performs processing to update the odds in real time according to changes in the situation during the match. For example, if an important player is injured, if there is an unexpected score, or if the flow of the match changes abruptly, the odds are adjusted immediately. The data analysis unit integrates information from multiple data sources and implements an advanced algorithm to support real-time decision-making. Furthermore, the data analysis unit can also analyze the user's past betting history and provide odds optimized for individual users.

The data analysis unit may receive the prediction result (probability distribution) output by the generative AI unit as an input and execute a Monte Carlo simulation, thereby generating thousands to tens of thousands of match development scenarios or traffic situation scenarios in parallel. Based on this simulation result, an expected value of odds or an optimal route is calculated. Also, the data analysis unit includes an anomaly detection algorithm (for example, Isolation Forest or Autoencoder), and can immediately detect a case where real-time data significantly deviates from a past statistical distribution (e.g., movement of a player suspected of match fixing, sudden road freezing), and dynamically adjust input weights to the generative AI model or generate a control signal to shift to a fail-safe mode.

The data analysis unit may be constituted by, for example, the computer 22 (the processor 28, etc.) of the data processing apparatus 12, or may be constituted by the specific processing unit 290, the specific processing program 56, the data generation model 58, or the like.

The 5G communication unit provides a communication means for acquiring real-time data with low latency and transmitting it to the data analysis unit. For example, it ensures real-time performance by receiving a live data stream from the match venue and instantly transferring it to the server. This makes it possible to respond quickly to changes in the situation during a match. By utilizing 5G technology, it processes large amounts of data at high speed and provides users with information that is updated in real time. For example, it is possible to acquire various data such as the position information of players during a match, the movement of the ball, and the reactions of the audience in real time and utilize them for analysis.

The 5G communication unit may be constituted by, for example, the computer 22 (the processor 28, etc.) and the communication I/F 26 of the data processing apparatus 12, or may be constituted by the specific processing unit 290, the specific processing program 56, or the like.

The user interface unit provides an environment where a user can view odds information that is updated in real time and place bets. The interface is designed to be visually easy to understand and has a function to display fluctuations in odds in a graph and to notify of important events. For example, a user can use a smartphone or tablet to check the progress of a match and the fluctuation of odds in real time, and quickly place a bet. The user interface has intuitive operability and is designed so that a user can easily make a betting selection. It also has a function to display the user's past betting history and current betting status, and provides information for the user to review their own betting strategy. Furthermore, the user interface is customizable according to the preferences of individual users and provides a variety of options to enhance the user experience.

### (Implementation Steps)

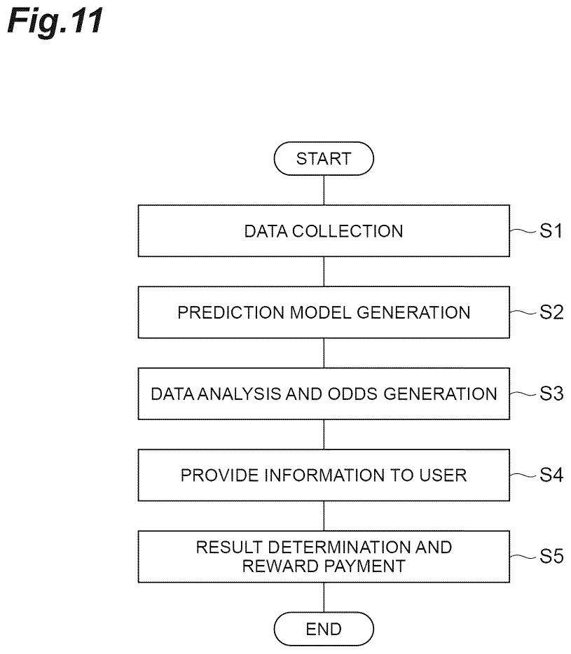

### Step 1: Data Collection (Refer to Step S1 of FIG. 11)

In this step, real-time data related to a sports event is collected. For example, a live data stream from the match venue is acquired using 5G communication technology. This data includes player position information, ball movement, match progress status, weather conditions, audience reactions, and the like. This data is necessary to quickly grasp changes in the situation during a match.

### Step 2: Prediction Model Generation by Generative AI (Refer to Step S2 of FIG. 11)

The generative AI unit generates a model for predicting the development of the match and the performance of players by combining the collected real-time data with past statistical data. Specific examples of prompt sentences include “Predict the goal success probability of player A in the next match” and “Calculate the probability of team B winning the next match”. The AI uses a machine learning algorithm to recognize complex patterns and improve prediction accuracy.

### Step 3: Data Analysis and Odds Generation (Refer to Step S3 of FIG. 11)

The data analysis unit uses the prediction model provided from the generative AI unit to calculate the probability of occurrence of events during a match and to generate betting odds. In this step, the odds are updated in real time according to changes in the situation during the match. For example, if an important player is injured, if there is an unexpected score, or if the flow of the match changes abruptly, the odds are adjusted immediately.

### Step 4: Information Provision by User Interface (Refer to Step S4 of FIG. 11)

The user interface unit provides an environment where a user can view odds information that is updated in real time and place bets. The interface is designed to be visually easy to understand and has a function to display fluctuations in odds in a graph and to notify of important events. A user can use a smartphone or tablet to check the progress of a match and the fluctuation of odds in real time, and quickly place a bet.

### Step 5: Result Determination and Reward Payment (Refer to Step S5 of FIG. 11)

After the match ends, the data analysis unit compares the actual results with the predicted results and determines the outcome of the bets. Winners are paid rewards based on the pre-set odds. In this step, it is required that the user's betting information is instantly recorded and processed promptly after the match ends.

### (Specific Use Case)

For example, in a certain sports event, before the start of the match, the generative AI unit collects past match data, player conditions, weather conditions, and team tactical information, and generates a model for predicting the development of the match based on these data. At this time, specific examples of prompt sentences to be read into the generative AI include “Predict the probability of player X scoring in the next match” and “Calculate the probability of team Y leading at the end of the first half”.

When the match starts, the 5G communication unit acquires real-time data from the match venue with low latency and transmits it to the data analysis unit. The data analysis unit uses the prediction model provided from the generative AI unit to calculate the probability of occurrence of events during a match and to generate betting odds. For example, if player Z is injured during the match, the data analysis unit immediately reflects this information and adjusts the odds.

The user interface unit provides an environment where a user can view odds information that is updated in real time and place bets. A user can use a smartphone or tablet to check the progress of a match and the fluctuation of odds in real time, and quickly place a bet. For example, a user can bet on whether player A will score next while watching the flow of the match.

After the match ends, the data analysis unit compares the actual results with the predicted results and determines the outcome of the bets. Winners are paid rewards based on the pre-set odds. Through this series of processes, users can experience sports events more excitingly, and it becomes possible to increase their interest in sports.

### Example 1.2

A flow of specific processing in Example 1.2 will be described. Each unit of the system described below is realized by the data processing apparatus 12 and the smart device 14. Also, the data processing apparatus 12 is referred to as a “server”, and the smart device 14 is referred to as a “terminal”.

An operation management system for an autonomous driving vehicle utilizing generative AI and 5G technology will be described more specifically and in detail. This system includes a generative AI unit, a data analysis unit, and a 5G communication unit, and each unit cooperates to realize efficient and safe operation of the autonomous driving vehicle.

First, the generative AI unit generates a model for predicting traffic flow and road congestion status based on real-time data acquired from a plurality of sensors mounted on the autonomous driving vehicle and past traffic data. For example, to predict the probability of congestion occurrence at an intersection ahead of the vehicle, it utilizes past traffic volume data and weather information. For example, it analyzes the increase/decrease patterns of traffic volume at the same time in the past and grasps the tendency of congestion on specific days of the week or at specific times. Also, as weather information, it considers precipitation such as rain and snow, temperature, wind speed, and the like, and predicts the impact these will have on the traffic flow. The generative AI unit can recognize these complex patterns and improve prediction accuracy using a machine learning algorithm.

The generative AI unit may integrate (sensor fusion) point cloud data by LiDAR (Light Detection and Ranging) and image data by the camera 42 using a Kalman filter or a particle filter, and specify 3D positions and velocity vectors of surrounding objects.

Next, the data analysis unit optimizes the vehicle's operation route using the prediction model provided from the generative AI unit. For example, it selects a route with less traffic and calculates a route that allows for smooth travel by considering signal timing. This makes it possible to reduce fuel consumption and shorten travel time. The data analysis unit integrates information from multiple data sources and implements an advanced algorithm to support real-time decision-making. For example, it can immediately reflect information on sudden accidents or road construction and recalculate the route. Also, the data analysis unit can consider the vehicle's remaining battery level and energy consumption rate, and propose an optimal route to a charging station.

The optimal route and the control instruction generated by the data analysis unit may be directly transmitted to a steering actuator, a brake actuator, and a throttle actuator via a CAN (Controller Area Network) bus in the vehicle. This processing is automatically executed only when the prediction probability by the generative AI exceeds a predetermined threshold (for example, 99.9%), and is controlled to be limited to a warning (HMI output) to the driver in other cases, thereby achieving optimization of safety and calculation resources.

The 5G communication unit provides a communication means for acquiring real-time data with low latency and transmitting it to the data analysis unit. For example, it ensures real-time performance by instantly transferring data acquired from the vehicle's sensors to a server. This makes it possible to respond quickly to changes in the situation during a match. By utilizing 5G technology, it processes large amounts of data at high speed and provides users with information that is updated in real time. For example, it is possible to acquire various data such as vehicle position information, speed, acceleration, and brake status in real time and utilize them for analysis.

In this way, by the generative AI unit, the data analysis unit, and the 5G communication unit working in cooperation, the autonomous driving vehicle can select an optimal route according to the traffic situation and operate efficiently and safely. This is expected to alleviate traffic congestion and improve energy efficiency, and can contribute to the optimization of urban traffic infrastructure. Furthermore, this system is equipped with an advanced control function to ensure passenger safety, allowing the vehicle to receive instructions to automatically perform a safe stop in an emergency.

### (System Configuration)

The system includes a generative AI unit, a data analysis unit, and a 5G communication unit. The generative AI unit generates a model for predicting traffic flow and road congestion status based on real-time data acquired from a plurality of sensors mounted on the autonomous driving vehicle and past traffic data. For example, to predict the probability of congestion occurrence at an intersection ahead of the vehicle, it utilizes past traffic volume data and weather information. For example, it analyzes the increase/decrease patterns of traffic volume at the same time in the past and grasps the tendency of congestion on specific days of the week or at specific times. Also, as weather information, it considers precipitation such as rain and snow, temperature, wind speed, and the like, and predicts the impact these will have on the traffic flow. The generative AI unit can recognize these complex patterns and improve prediction accuracy using a machine learning algorithm. Specific examples of prompt sentences to be read into the generative AI include “Predict the probability of congestion at the next intersection” and “Calculate the optimal route to the destination”.

The data analysis unit optimizes the vehicle's operation route using the prediction model provided from the generative AI unit. For example, it selects a route with less traffic and calculates a route that allows for smooth travel by considering signal timing. This makes it possible to reduce fuel consumption and shorten travel time. The data analysis unit integrates information from multiple data sources and implements an advanced algorithm to support real-time decision-making. For example, it can immediately reflect information on sudden accidents or road construction and recalculate the route. Also, the data analysis unit can consider the vehicle's remaining battery level and energy consumption rate, and propose an optimal route to a charging station. Furthermore, the data analysis unit analyzes the vehicle's operation history and provides feedback for improving operation efficiency.

The 5G communication unit provides a communication means for acquiring real-time data with low latency and transmitting it to the data analysis unit. For example, it ensures real-time performance by instantly transferring data acquired from the vehicle's sensors to a server. This makes it possible to respond quickly to changes in the situation during a match. By utilizing 5G technology, it processes large amounts of data at high speed and provides users with information that is updated in real time. For example, it is possible to acquire various data such as vehicle position information, speed, acceleration, and brake status in real time and utilize them for analysis. Also, the 5G communication unit enables communication with other vehicles and infrastructure, and provides a foundation for realizing cooperative operation.

In this way, by the generative AI unit, the data analysis unit, and the 5G communication unit working in cooperation, the autonomous driving vehicle can select an optimal route according to the traffic situation and operate efficiently and safely. This is expected to alleviate traffic congestion and improve energy efficiency, and can contribute to the optimization of urban traffic infrastructure. Furthermore, this system is equipped with an advanced control function to ensure passenger safety, allowing the vehicle to receive instructions to automatically perform a safe stop in an emergency.

### (Implementation Steps)

### Step 1: Real-Time Data Collection

Real-time data such as the surrounding traffic situation, road conditions, and weather information are collected from a plurality of sensors mounted on the autonomous driving vehicle. For example, using LiDAR, cameras, and radar, the distance to the vehicle ahead, the movement of pedestrians, the state of traffic lights, the slipperiness of the road, and the like are detected. This data serves as important material for judgment in the operation of the vehicle.

### Step 2: Prediction Model Generation by Generative AI

Based on the collected real-time data and past traffic data, the generative AI generates a model that predicts the flow of traffic and the congestion status of roads. Specific examples of prompt sentences include “Predict the probability of congestion at the next intersection” and “Calculate the optimal route to the destination”. The generative AI uses a machine learning algorithm to recognize these complex patterns and improve prediction accuracy.

### Step 3: Data Analysis and Route Optimization

Using the prediction model provided from the generative AI, the data analysis unit optimizes the vehicle's operation route. It selects a route with less traffic and calculates a route that allows for smooth travel by considering signal timing. This makes it possible to reduce fuel consumption and shorten travel time. Furthermore, it can immediately reflect information on sudden accidents or road construction and recalculate the route.

### Step 4: Data Transmission Via 5G Communication

The 5G communication unit acquires real-time data with low latency and transmits it to the data analysis unit. It ensures real-time performance by instantly transferring data acquired from the vehicle's sensors to a server. This makes it possible to respond quickly to changes in the traffic situation. By utilizing 5G technology, it processes large amounts of data at high speed and provides users with information that is updated in real time.

### Step 5: Vehicle Control and Operation Management

The optimized route information is transmitted to the autonomous driving vehicle to control the vehicle's operation. The vehicle adjusts its speed and direction of travel based on the route information that is updated in real time. For example, to avoid sudden braking, it adjusts the speed by predicting the movement of the vehicle ahead. Also, in an emergency, the vehicle can receive instructions to automatically perform a safe stop.

### (Specific Use Case)

For example, in the operation management of autonomous driving vehicles in an urban area, the vehicle monitors the surrounding traffic situation in real time using a plurality of sensors. The sensors detect the distance to the vehicle ahead, the movement of pedestrians, the state of traffic lights, the slipperiness of the road, and the like. This data is instantly transmitted to a server using 5G communication technology.

The generative AI generates a model that predicts the flow of traffic and the congestion status of roads based on the collected real-time data and past traffic data. Specific examples of prompt sentences include “Predict the probability of congestion at the next intersection” and “Calculate the optimal route to the destination”. The generative AI uses a machine learning algorithm to recognize these complex patterns and improve prediction accuracy.

The data analysis unit optimizes the vehicle's operation route using the prediction model provided from the generative AI. For example, it selects a route with less traffic and calculates a route that allows for smooth travel by considering signal timing. This makes it possible to reduce fuel consumption and shorten travel time. Furthermore, it can immediately reflect information on sudden accidents or road construction and recalculate the route.

The vehicle controls its operation based on the optimized route information. For example, to avoid sudden braking, it adjusts the speed by predicting the movement of the vehicle ahead. Also, in an emergency, the vehicle can receive instructions to automatically perform a safe stop. In this way, the autonomous driving vehicle can operate efficiently and safely, and can contribute to the alleviation of urban traffic congestion and the improvement of energy efficiency.

The specific processing unit 290 transmits a result of the specific processing to the smart device 14. In the smart device 14, the control unit 46A causes the output device 40 to output the result of the specific processing. The microphone 38B acquires voice indicating a user input for the result of the specific processing. The control unit 46A transmits voice data indicating the user input acquired by the microphone 38B to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart device 14.

### Second Embodiment

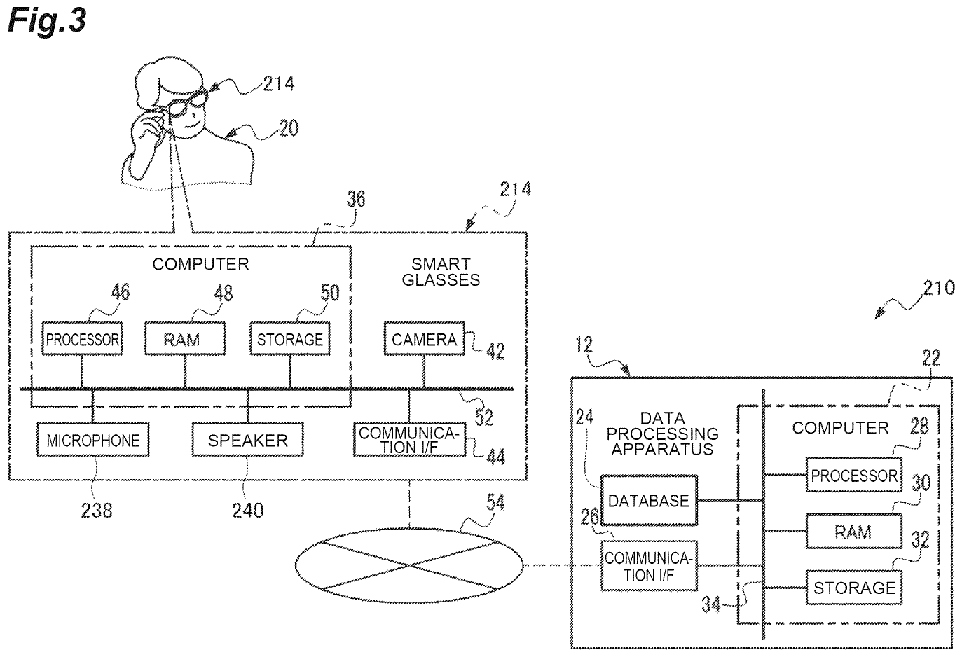

FIG. 3 illustrates an example of a configuration of a data processing system 210 according to a second embodiment.

As illustrated in FIG. 3, the data processing system 210 includes a data processing apparatus 12 and smart glasses 214. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The smart glasses 214 include a computer 36, a microphone 238, a speaker 240, a camera 42, and a communication I/F 44. The computer 36 includes a processor 46, a RAM 48, and a storage 50. The processor 46, the RAM 48, and the storage 50 are connected to a bus 52. Also, the microphone 238, the speaker 240, and the camera 42 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

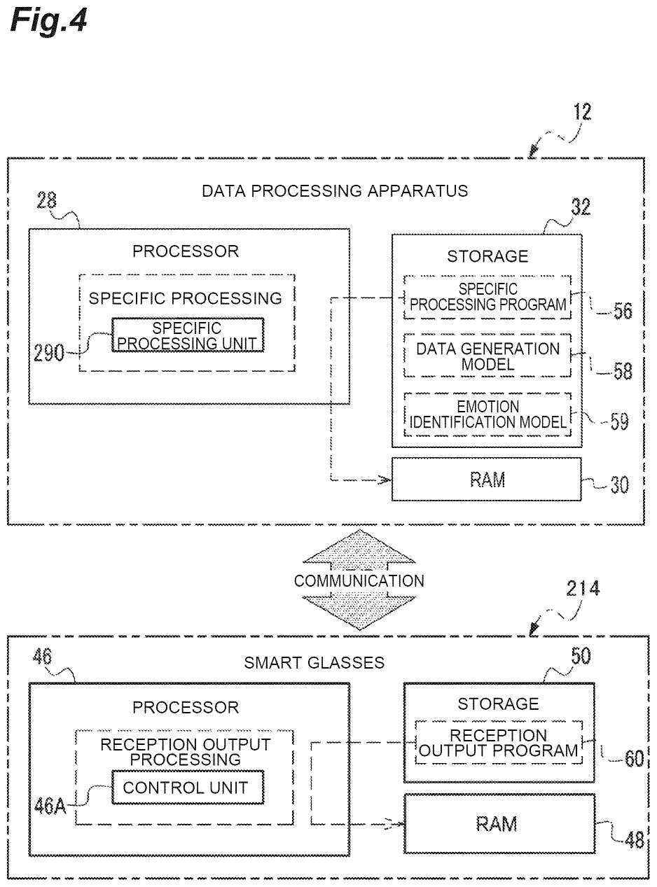

FIG. 4 illustrates an example of main functions of the data processing apparatus 12 and the smart glasses 214. As illustrated in FIG. 4, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290. The specific processing unit 290 can estimate a user's emotion using the emotion identification model 59 and perform specific processing using the user's emotion. In an emotion estimation function (emotion identification function) using the emotion identification model 59, various estimations and predictions regarding the user's emotion, including estimation and prediction of the user's emotion, are performed, but is not limited to such examples. Also, the estimation and prediction of emotion include, for example, analysis (analytics) of emotion and the like.

In the smart glasses 214, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48. Note that the smart glasses 214 may have a data generation model and an emotion identification model similar to the data generation model 58 and the emotion identification model 59, and can also perform processing similar to that of the specific processing unit 290 using these models.

Next, specific processing by the specific processing unit 290 of the data processing apparatus 12 will be described. Each unit of the system described below is realized by the data processing apparatus 12 and the smart glasses 214. In the following description, the data processing apparatus 12 is referred to as a “server”, and the smart glasses 214 are referred to as a “terminal”.

### Example 2.1

Since the flow of the specific processing is the same as that in Example 1.1 described in the first embodiment, a description thereof is omitted.

### Example 2.2

Since the flow of the specific processing is the same as that in Example 1.2 described in the first embodiment, a description thereof is omitted.

The specific processing unit 290 transmits a result of the specific processing to the smart glasses 214. In the smart glasses 214, the control unit 46A causes the speaker 240 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes Als other than generative AI. AIs other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the smart glasses 214.

### Third Embodiment

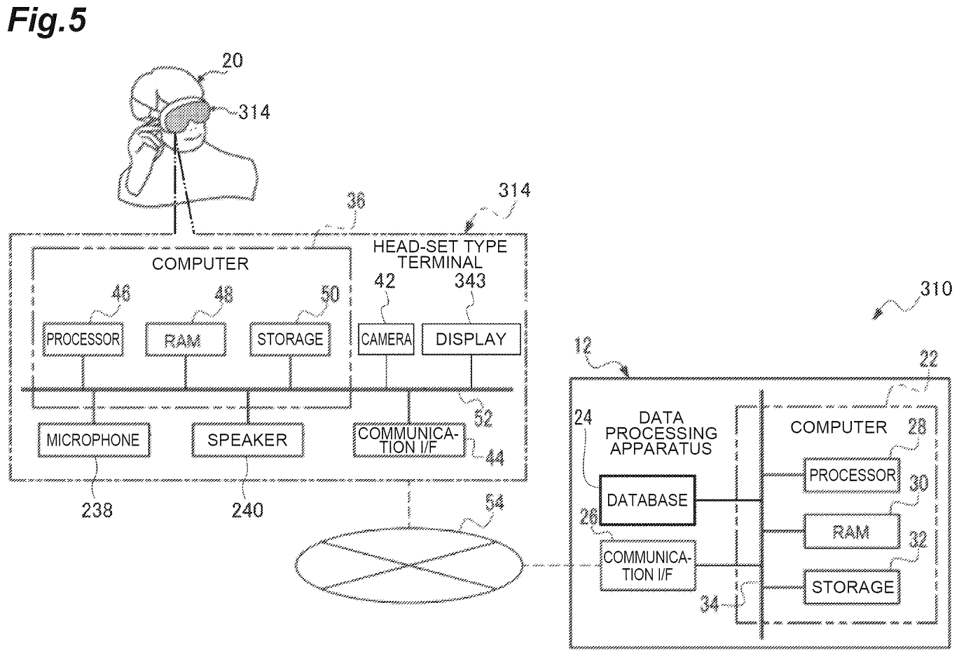

FIG. 5 illustrates an example of a configuration of a data processing system 310 according to a third embodiment.

As illustrated in FIG. 5, the data processing system 310 includes a data processing apparatus 12 and a headset-type terminal 314. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The headset-type terminal 314 includes a computer 36, a microphone 238, a speaker 240, a camera 42, a communication I/F 44, and a display 343. The computer 36 includes a processor 46, a RAM 48, and a storage 50. The processor 46, the RAM 48, and the storage 50 are connected to a bus 52. Also, the microphone 238, the speaker 240, the camera 42, and the display 343 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

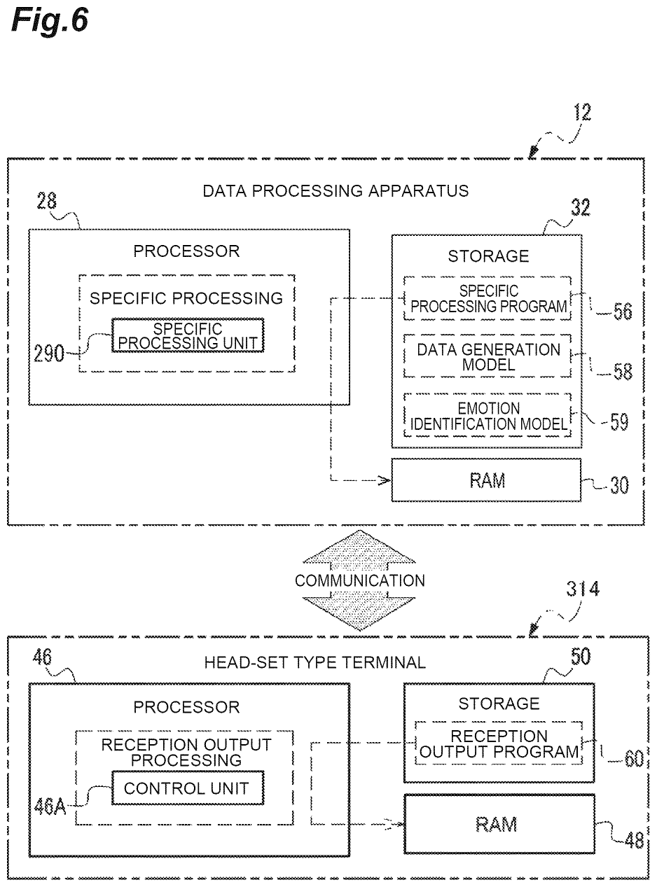

FIG. 6 illustrates an example of main functions of the data processing apparatus 12 and the headset-type terminal 314. As illustrated in FIG. 6, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the headset-type terminal 314, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the headset-type terminal 314. In the following description, the data processing apparatus 12 is referred to as a “server”, and the headset-type terminal 314 is referred to as a “terminal”.

### Example 3.1

Since the flow of the specific processing is the same as that in Example 1.1 described in the first embodiment, a description thereof is omitted.

### Example 3.2

Since the flow of the specific processing is the same as that in Example 1.2 described in the first embodiment, a description thereof is omitted.

The specific processing unit 290 transmits a result of the specific processing to the headset-type terminal 314. In the headset-type terminal 314, the control unit 46A causes the speaker 240 and the display 343 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the headset-type terminal 314.

### Fourth Embodiment

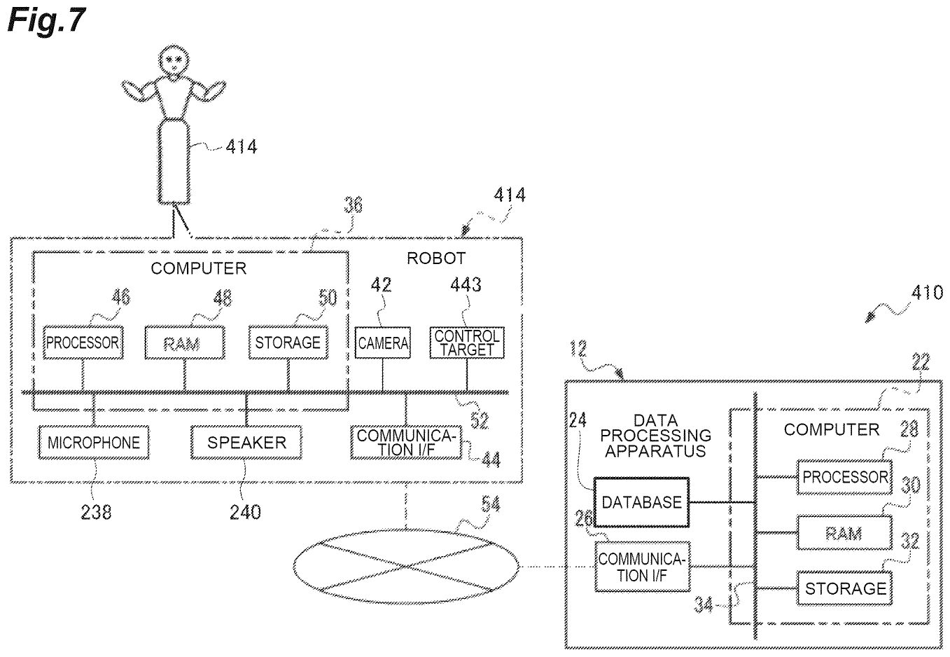

FIG. 7 illustrates an example of a configuration of a data processing system 410 according to a fourth embodiment.

As illustrated in FIG. 7, the data processing system 410 includes a data processing apparatus 12 and a robot 414. An example of the data processing apparatus 12 includes a server.

The data processing apparatus 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. Also, the database 24 and the communication I/F 26 are also connected to the bus 34. The communication I/F 26 is connected to a network 54. An example of the network 54 includes a WAN (Wide Area Network) and/or a LAN (Local Area Network), and the like.

The robot 414 includes a computer 36, a microphone 238, a speaker 240, a camera 42, a communication I/F 44, and a control target 443. The computer 36 includes a processor 46, a RAM 48, and a storage 50. The processor 46, the RAM 48, and the storage 50 are connected to a bus 52. Also, the microphone 238, the speaker 240, the camera 42, and the control target 443 are also connected to the bus 52.

The microphone 238 receives an instruction or the like from a user 20 by receiving voice uttered by the user 20. The microphone 238 captures the voice uttered by the user 20, converts the captured voice into voice data, and outputs the voice data to the processor 46. The speaker 240 outputs voice in accordance with an instruction from the processor 46.

The camera 42 is a small digital camera on which an optical system such as a lens, a diaphragm, and a shutter, and an image sensor such as a CMOS (Complementary Metal-Oxide-Semiconductor) image sensor or a CCD (Charge Coupled Device) image sensor are mounted, and images the surroundings of the user 20 (for example, an imaging range defined by an angle of view corresponding to the width of the field of view of a general person with normal vision).

The communication I/F 44 is connected to the network 54. The communication I/Fs 44 and 26 manage exchange of various information between the processor 46 and the processor 28 via the network 54. The exchange of various information between the processor 46 and the processor 28 using the communication I/Fs 44 and 26 is performed in a secure state.

The control target 443 includes a display device, an LED of an eye part, and motors that drive an arm, a hand, a leg, and the like. The posture and gestures of the robot 414 are controlled by controlling the motors of the arm, hand, leg, and the like. A part of the emotions of the robot 414 can be expressed by controlling these motors. Also, the facial expression of the robot 414 can also be expressed by controlling the light emission state of the LED of the eye part of the robot 414.

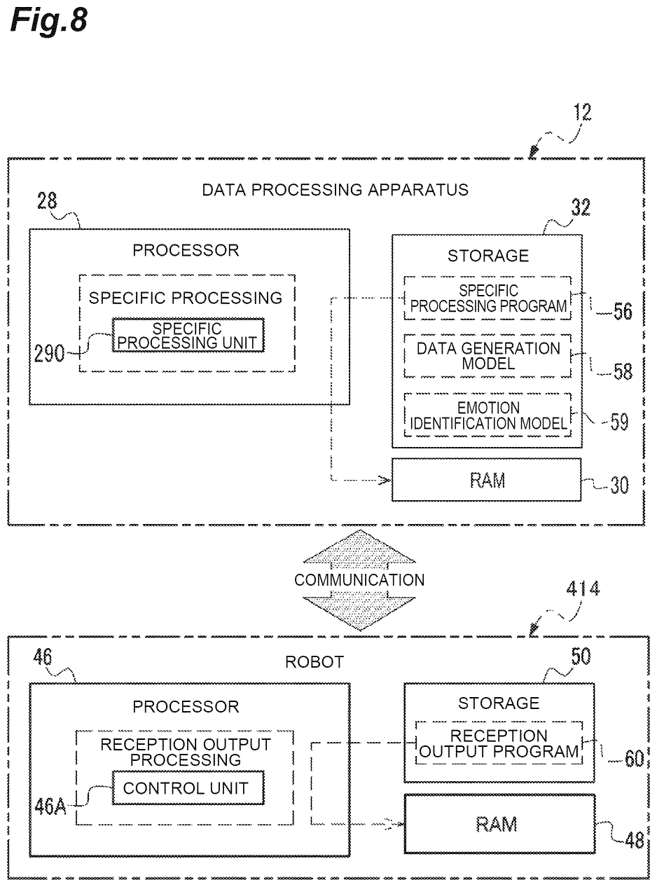

FIG. 8 illustrates an example of main functions of the data processing apparatus 12 and the robot 414. As illustrated in FIG. 8, in the data processing apparatus 12, specific processing is performed by the processor 28. A specific processing program 56 is stored in the storage 32.

The specific processing program 56 is an example of a “program” according to the technology of the present disclosure. The processor 28 reads the specific processing program 56 from the storage 32 and executes the read specific processing program 56 on the RAM 30. The specific processing is realized by the processor 28 operating as a specific processing unit 290 in accordance with the specific processing program 56 executed on the RAM 30.

A data generation model 58 and an emotion identification model 59 are stored in the storage 32. The data generation model 58 and the emotion identification model 59 are used by the specific processing unit 290.

In the robot 414, reception output processing is performed by the processor 46. A reception output program 60 is stored in the storage 50. The processor 46 reads the reception output program 60 from the storage 50 and executes the read reception output program 60 on the RAM 48. The reception output processing is realized by the processor 46 operating as a control unit 46A in accordance with the reception output program 60 executed on the RAM 48.

Next, specific processing by the specific processing unit 290 of the data processing apparatus 12 will be described. Each unit of the system described below is realized by the data processing apparatus 12 and the robot 414. In the following description, the data processing apparatus 12 is referred to as a “server”, and the robot 414 is referred to as a “terminal”.

### Example 4.1

Since the flow of the specific processing is the same as that in Example 1.1 described in the first embodiment, a description thereof is omitted.

### Example 4.2

Since the flow of the specific processing is the same as that in Example 1.2 described in the first embodiment, a description thereof is omitted.

The specific processing unit 290 transmits a result of the specific processing to the robot 414. In the robot 414, the control unit 46A causes the speaker 240 and the control target 443 to output the result of the specific processing. The microphone 238 acquires voice indicating a user input for the result of the specific processing. The control unit 46A transmits voice data indicating the user input acquired by the microphone 238 to the data processing apparatus 12. In the data processing apparatus 12, the specific processing unit 290 acquires the voice data.

The data generation model 58 is a so-called generative AI (Artificial Intelligence). An example of the data generation model 58 includes a generative AI such as ChatGPT (registered trademark) (Internet search <URL: https://openai.com/blog/chatgpt>). The data generation model 58 is obtained by causing a neural network to perform deep learning. A prompt including an instruction is input to the data generation model 58, and inference data such as voice data indicating voice, text data indicating text, and image data indicating an image (for example, still image data or moving image data) is input. The data generation model 58 infers the input inference data in accordance with the instruction indicated by the prompt, and outputs an inference result in one or more data formats among voice data, text data, image data, and the like. The data generation model 58 includes, for example, a text generation AI, an image generation AI, a multimodal generation AI, and the like. Here, inference refers to, for example, analysis, classification, prediction, and/or summarization, and the like. The specific processing unit 290 performs the above-described specific processing while using the data generation model 58. The data generation model 58 may be a model fine-tuned to output an inference result from a prompt that does not include an instruction, and in this case, the data generation model 58 can output an inference result from a prompt that does not include an instruction. In the data processing apparatus 12 and the like, a plurality of types of data generation models 58 are included, and the data generation model 58 includes AIs other than generative AI. Als other than generative AI are, for example, linear regression, logistic regression, a decision tree, a random forest, a support vector machine (SVM), k-means clustering, a convolutional neural network (CNN), a recurrent neural network (RNN), a generative adversarial network (GAN), or naive Bayes, and can perform various processes, but is not limited to such examples. Also, the AI may be an AI agent. Also, when the processing of each unit described above is performed by an AI, the processing is partially or entirely performed by the AI, but is not limited to such examples. Also, a process implemented by an AI including a generative AI may be replaced with a rule-based process, and a rule-based process may be replaced with a process implemented by an AI including a generative AI.

Also, the processing by the data processing system 10 described above is executed by the specific processing unit 290 of the data processing apparatus 12 or the control unit 46A of the smart device 14, but may also be executed by the specific processing unit 290 of the data processing apparatus 12 and the control unit 46A of the smart device 14. Also, the specific processing unit 290 of the data processing apparatus 12 acquires or collects information necessary for the processing from the smart device 14 or an external device, and the smart device 14 acquires or collects information necessary for the processing from the data processing apparatus 12 or an external device.

For example, a collection unit is realized by the control unit 46A of the smart device 14 or the specific processing unit 290 of the data processing apparatus 12. For example, an acquisition unit acquires step count data using the camera 42 or the communication I/F 44 of the smart device 14, and the data is processed by the specific processing unit 290 of the data processing apparatus 12. For example, an analysis unit is realized by the specific processing unit 290 of the data processing apparatus 12, and analyzes data from the collection unit and the acquisition unit. For example, a generation unit is realized by the specific processing unit 290 of the data processing apparatus 12, and generates a cooking menu using a generative AI. For example, a provision unit is realized by the output device 40 of the smart device 14 or the specific processing unit 290 of the data processing apparatus 12, and provides the generated cooking menu to a user. The correspondence relationship between each unit and the device or the control unit is not limited to the above-described example, and various changes are possible.

An example form in which the specific processing is performed by the data processing apparatus 12 has been described, but the technology of the present disclosure is not limited to this, and the specific processing may be performed by the robot 414.

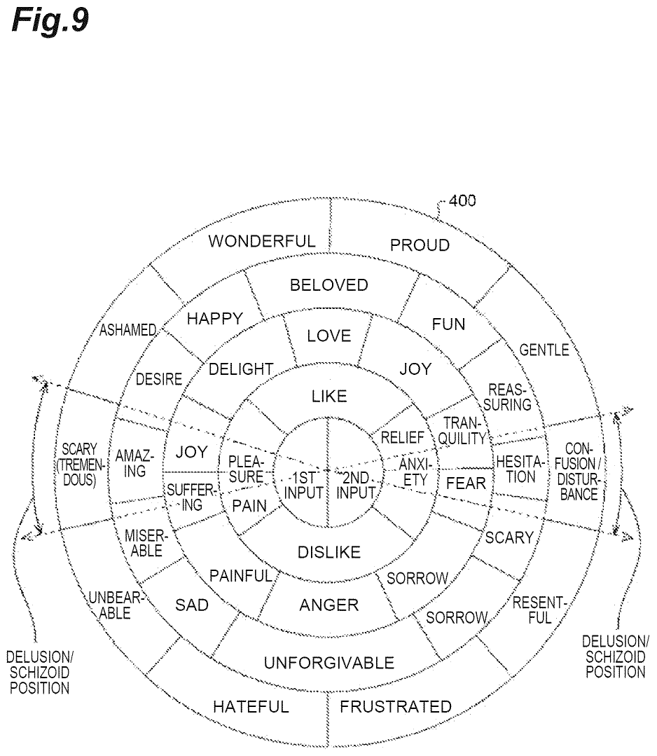

Note that the emotion identification model 59 as an emotion engine may determine a user's emotion according to a specific mapping. For example, the emotion identification model 59 may determine the user's emotion according to an emotion map (see FIG. 9), which is a specific mapping. Also, the emotion identification model 59 may similarly determine the robot's emotion, and the specific processing unit 290 may perform specific processing using the robot's emotion.

FIG. 9 is a diagram illustrating an emotion map 400 on which a plurality of emotions are mapped. In the emotion map 400, emotions are arranged in concentric circles radiating from the center. The closer to the center of the concentric circles, the more primitive the state of the emotion is arranged. On the outer side of the concentric circles, emotions representing states and actions arising from a state of mind are arranged. Emotion is a concept that also includes affect and mental states. On the left side of the concentric circles, emotions generated from reactions that generally occur in the brain are arranged. On the right side of the concentric circles, emotions that are generally induced by situational judgment are arranged. In the upward and downward directions of the concentric circles, emotions that are generated from reactions that generally occur in the brain and are induced by situational judgment are arranged. Also, on the upper side of the concentric circles, “pleasant” emotions are arranged, and on the lower side, “unpleasant” emotions are arranged. In this way, in the emotion map 400, a plurality of emotions are mapped based on the structure in which emotions are generated, and emotions that are likely to occur at the same time are mapped close to each other.

These emotions are distributed in the 3 o'clock direction of the emotion map 400, and usually go back and forth between relief and anxiety. In the right half of the emotion map 400, situational awareness is superior to internal sensations, resulting in a calm impression.

Since the inside of the emotion map 400 represents the inside of the mind and the outside of the emotion map 400 represents actions, the further one goes to the outside of the emotion map 400, the more visible (manifested in action) the emotion becomes.

Here, human emotions are based on various balances such as posture and blood sugar levels, and show a state of unpleasantness when those balances move away from the ideal, and a state of pleasantness when they approach the ideal. In robots, automobiles, motorcycles, and the like as well, emotions can be created based on various balances such as posture and remaining battery level, so as to show a state of unpleasantness when those balances move away from the ideal, and a state of pleasantness when they approach the ideal. The emotion map may be generated based on, for example, Dr. Mitsuyoshi's emotion map (Research on a speech emotion recognition and brain physiological signal analysis system of affect, Tokushima University, doctoral dissertation: https://ci.nii.ac.jp/naid/500000375379). In the left half of the emotion map, emotions belonging to a region called “reaction” where sensation is dominant are arranged. Also, in the right half of the emotion map, emotions belonging to a region called “situation” where situational awareness is dominant are arranged.

In the emotion map, two emotions that promote learning are defined. One is an emotion around the middle of negative “remorse” and “reflection” on the situation side. That is, it is when a negative emotion such as “I never want to feel this way again” or “I don't want to be scolded anymore” arises in the robot. The other is an emotion around positive “desire” on the reaction side. That is, it is when there is a positive feeling such as “I want more” or “I want to know more”.

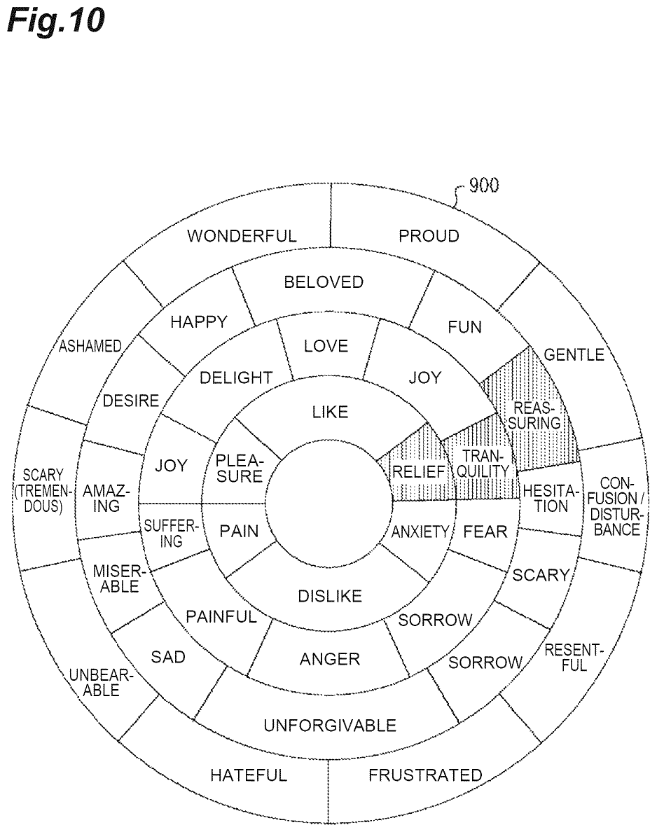

The emotion identification model 59 inputs a user input into a pre-trained neural network, acquires an emotion value indicating each emotion shown in the emotion map 400, and determines the user's emotion. This neural network is pre-trained based on a plurality of learning data that are combinations of user inputs and emotion values indicating each emotion shown in the emotion map 400. Also, this neural network is trained such that emotions arranged close to each other have close values, as in the emotion map 900 shown in FIG. 10. FIG. 10 shows an example in which a plurality of emotions, “relief,” “peace of mind,” and “reassured,” have close emotion values.

Although the system according to the present disclosure has been described above mainly with respect to the functions of the data processing apparatus 12, the system according to the present disclosure is not necessarily implemented in a server. The system according to the present disclosure may be implemented as a general information processing system. The present disclosure may be implemented as, for example, a software program that runs on a personal computer, or an application that runs on a smartphone or the like. The method according to the present disclosure may be provided to a user in a Saas (Software as a Service) format.

An example form in which the specific processing is performed by one computer 22 has been described, but the technology of the present disclosure is not limited to this, and distributed processing for the specific processing may be performed by a plurality of computers including the computer 22. For example, the data generation model 58 may be provided in an external device of the data processing apparatus 12, and the external device may generate data according to the input data.

An example form in which the specific processing program 56 is stored in the storage 32 has been described, but the technology of the present disclosure is not limited to this. For example, the specific processing program 56 may be stored in a portable computer-readable non-transitory storage medium such as a USB (Universal Serial Bus) memory. The specific processing program 56 stored in the non-transitory storage medium is installed in the computer 22 of the data processing apparatus 12. The processor 28 executes the specific processing according to the specific processing program 56.

Also, the specific processing program 56 may be stored in a storage device such as a server connected to the data processing apparatus 12 via the network 54, and the specific processing program 56 may be downloaded in response to a request from the data processing apparatus 12 and installed in the computer 22.

Note that it is not necessary to store all of the specific processing program 56 in a storage device such as a server connected to the data processing apparatus 12 via the network 54, or to store all of the specific processing program 56 in the storage 32, and a part of the specific processing program 56 may be stored.

As hardware resources for executing the specific processing, various processors shown below can be used. Examples of the processor include a CPU, which is a general-purpose processor that functions as a hardware resource for executing the specific processing by executing software, that is, a program. Also, examples of the processor include a dedicated electric circuit, which is a processor having a circuit configuration specifically designed to execute specific processing, such as an FPGA (Field-Programmable Gate Array), a PLD (Programmable Logic Device), or an ASIC (Application Specific Integrated Circuit). A memory is built in or connected to any of the processors, and any of the processors executes the specific processing by using the memory.

The hardware resource that executes the specific processing may be configured by one of these various processors, or may be configured by a combination of two or more processors of the same type or different types (for example, a combination of a plurality of FPGAs, or a combination of a CPU and an FPGA). Also, the hardware resource that executes the specific processing may be one processor.

As an example of a configuration with one processor, first, there is a form in which one processor is configured by a combination of one or more CPUs and software, and this processor functions as a hardware resource for executing the specific processing. Second, there is a form in which a processor that realizes the functions of an entire system including a plurality of hardware resources for executing the specific processing with one IC chip, as represented by an SoC (System-on-a-chip) or the like, is used. In this way, the specific processing is realized using one or more of the various processors described above as hardware resources.

Furthermore, as a hardware structure of these various processors, an electric circuit in which circuit elements such as semiconductor elements are combined can be used. Also, the specific processing described above is merely an example. Therefore, it goes without saying that unnecessary steps may be deleted, new steps may be added, or the processing order may be changed within a scope that does not depart from the gist.

The processing of the specific processing unit 290 described above, particularly the generative AI unit and the data analysis unit, may be executed using not only a CPU but also a parallel arithmetic processor such as a GPU (Graphics Processing Unit) or a TPU (Tensor Processing Unit). In particular, matrix operations in the generative AI model are parallelized using a large number of cores of the GPU, and reading and writing of data are performed at high speed via a shared memory area on the RAM 30. Also, large-capacity real-time data received via the 5G communication unit is temporarily stored in the RAM 30 in a ring buffer format, and older data is overwritten in order, making it possible to always perform inference on the latest data set while keeping memory usage constant.

The description and illustrations shown above are detailed descriptions of the parts related to the technology of the present disclosure, and are merely an example of the technology of the present disclosure. For example, the description regarding the above-described configuration, function, operation, and effect is a description regarding an example of the configuration, function, operation, and effect of the part related to the technology of the present disclosure. Therefore, it goes without saying that unnecessary parts may be deleted, new elements may be added, or replacements may be made to the description and illustrations shown above within a scope that does not depart from the gist of the technology of the present disclosure. Also, in order to avoid confusion and facilitate understanding of the parts related to the technology of the present disclosure, in the description and illustrations shown above, descriptions regarding common general technical knowledge and the like that do not require particular explanation for enabling the implementation of the technology of the present disclosure are omitted.

All documents, patent applications, and technical standards described in this specification are incorporated herein by reference to the same extent as if each individual document, patent application, and technical standard were specifically and individually indicated to be incorporated by reference.

It is to be understood that not all aspects, advantages and features described herein may necessarily be achieved by, or included in, any one particular example. Indeed, having described and illustrated various examples herein, it should be apparent that other examples may be modified in arrangement and detail.

A system for managing operation of an autonomous driving vehicle, comprising a generative AI unit, a data analysis unit, and a 5G communication unit, wherein the generative AI unit generates a model for predicting traffic flow and road congestion status based on real-time data acquired from sensors mounted on the vehicle and past traffic data, the data analysis unit uses the model provided from the generative AI unit to optimize the vehicle's operation route and performs processing to update the route in real time according to changes in traffic conditions, and the 5G communication unit provides a communication means for acquiring the real-time data with low latency and transmitting it to the data analysis unit.

In some examples, the data analysis unit may further include means for selecting a route with less traffic, means for calculating a route that allows for smooth travel by considering signal timing, and means for realizing a reduction in fuel consumption and travel time. The data analysis unit implements an advanced algorithm for integrating information from multiple data sources and supporting real-time decision-making.

In some examples, the generative AI unit may further include means for predicting changes in traffic volume during specific time periods, the tendency for congestion to occur at specific intersections, and changes in road conditions due to weather, and means for controlling the operation of the vehicle, wherein in an emergency, the vehicle can receive instructions to automatically perform a safe stop. The generative AI unit uses a machine learning algorithm to recognize complex patterns and improve prediction accuracy.

An example system for predicting progress of a sports match in real time may include circuitry. The circuitry is configured to: acquire real-time data related to a sports event; generate a model for predicting the development of a match and the performance of players by combining the real-time data and past statistical data; calculate a probability of occurrence of an event during the match using the model; and generate betting odds based on the probability of occurrence.

In some examples, generating the odds may include: updating the odds in real time according to a change in a situation during the match; and causing a user interface to display a fluctuation of the odds in a graph.

In some examples, the circuit may be further configured to: determine a result of a bet by comparing an actual result and a predicted result after the match ends; and calculate a reward to be paid to a winner based on the odds.

An example method of predicting progress of a sports match in real time may include: acquiring real-time data related to a sports event; generating a model for predicting development of a match and performance of players by combining the real-time data and past statistical data; calculating a probability of occurrence of an event during the match using the model; and generating betting odds based on the probability of occurrence.

What is claimed is:

1. A system for predicting progress of a sports match in real time, the system comprising circuitry,
wherein the circuitry is configured to:
acquire real-time data related to a sports event;
generate a model for predicting the development of a match and the performance of players by combining the real-time data and past statistical data;
calculate a probability of occurrence of an event during the match using the model; and
generate betting odds based on the probability of occurrence.

2. The system according to claim 1, wherein generating the odds includes:
updating the odds in real time according to a change in a situation during the match; and
causing a user interface to display a fluctuation of the odds in a graph.

3. The system according to claim 1, wherein the circuitry is further configured to:
determine a result of a bet by comparing an actual result and a predicted result after the match ends; and
calculate a reward to be paid to a winner based on the odds.

4. A method of predicting progress of a sports match in real time, the method comprising:
acquiring real-time data related to a sports event;
generating a model for predicting development of a match and performance of players by combining the real-time data and past statistical data;
calculating a probability of occurrence of an event during the match using the model; and
generating betting odds based on the probability of occurrence.
